(19) United States
(12) Patent Application Publication
(10) Pub. No.: US 2026/0005578 A1
(43) Pub. Date: Jan. 1, 2026

(54) HAPTIC CONTROL DEVICE

(71) Applicant: INVENTUS ENGINEERING GMBH, St. Anton i.M. (AT)

(72) Inventor: Stefan Battlogg, St. Anton i.M. (AT)

(21) Appl. No.: 18/879,398

(22) PCT Filed: Jun. 27, 2023
(86) PCT No.: PCT/EP2023/067503

§ 371 Date: Dec. 27, 2024

(30) Foreign Application Priority Data
Jun. 27, 2022 (DE) 10 2022 115 924.8

(51) Int. Cl. H02K 7/102; G03B 17/18; G04G 21/08; H02K 5/10; H02K 7/00

(52) U.S. Cl. CPC H02K 7/102; H02K 5/10; H02K 7/003; G03B 17/18; G04G 21/08

(57) ABSTRACT

A control device of a stator unit that can be fastened to a carrier structure and having a rotary knob unit that rotates relative to the stator unit for setting operating states by means of rotary movements and having a magnetorheological braking device having two brake components. One brake component is provided by the stator unit and another brake component is provided by the rotary knob unit. The two brake components can be rotated relative to one another about an axis of rotation. A first brake component has a magnetically conductive core and the second brake component comprises a casing part extending around the first brake component. A gap, which is filled with a magnetorheological medium, is formed between the first and second brake component. An electrical coil, which surrounds the core and is wound around the axis of rotation, is received between the casing part and the core.

The present invention relates to a haptic operating device with at least one stator unit attached to at least one support body and with at least one rotary button unit which can be rotated about the stator unit for setting operating states by means of rotary movements. The rotational movements can be specifically braked using a magnetorheological braking device, for example, for haptic feedback.

There is usually only very limited space available to accommodate the operating device in a device. This is the case, for example, if the operating device is in a smart device and, for example, a smartwatch or a smartphone or in other confined areas and, for example, is used as a trigger in a camera. A quite compact operating device is, for example, known from DE 10 2015 110 634 Al.

Despite the limited space, the bearing of the rotor unit must be able to absorb considerable forces, for example the pressure of a thumb or index finger when rotating. The braking device also requires a large amount of installation space in order to be able to reliably brake and even completely block (high torque) the (finger) forces (tangential forces) and the resulting movement (rotation; torque). At the same time, the haptic feedback must also be very precise so that, for example, no high base torque may occur. In addition, the gap must be reliably sealed so that the magnetorheological medium does not leak out. However, these requirements cannot be met by simply scaling or reducing the size of the known operating devices.

In contrast, the object of the present invention is to provide a particularly compact haptic operating device which meets these requirements as far as possible. For example, an external diameter of less than 8 mm should be possible.

This task is solved by a haptic operating device with the features of claim 1. Preferred developments of the invention are the subject of the subclaims. Further advantages and features of the present invention emerge from the general description and from the description of the exemplary embodiments.

The haptic operating device according to the invention comprises at least one stator unit that can be attached to a support structure. The operating device comprises at least one rotary button unit that can be rotated relative to the stator unit. In particular, using rotary movements or by turning the rotary knob unit you can set the operating states. The operating device comprises at least one magnetorheological braking device with at least two braking components. One of the braking components is provided by the stator unit. Another of the braking components is provided by the knob unit. The two brake components can be rotated relative to one another, in particular continuously, about an axis of rotation. A first brake component comprises at least one core made of a magnetically conductive material. A second braking component comprises a casing part which preferably extends around the first braking component. In particular, the casing part is hollow. A circumferential gap is formed between the first and second braking components and is at least partially filled with a magnetorheological medium. Between At least one electrical coil wound around the axis of rotation is accommodated in the casing part and the core. In particular, the electrical coil surrounds the core at least in sections.

Such an operating device offers an advantageous basis for small or smallest scaling. The following embodiments each represent advantageous solutions on their own or in a suitable combination with one another in order to dimension this base to a very small scale and at the same time to achieve a particularly low basic torque, reliable/robust storage and sealing as well as very precise haptic feedback.

In particular, the stator unit comprises at least one hollow axle connected in a rotationally fixed manner to the first brake component. In particular, the rotary knob unit comprises a shaft connected (in rotationally fixed manner) to the second brake component. In particular, the shaft runs through the hollow axle. In particular, the shaft is rotatably mounted in the hollow axle. This enables a resilient and smooth-running bearing even with the smallest scaling. In particular, the hollow axle is rotatably mounted in the hollow axle via at least one plain bearing and preferably via at least two plain bearings. In particular, the plain bearing comprises at least one sleeve-like part. In particular, the part is made of Teflon or another slippery or slip-modified material or plastic. Other suitable bearings are also possible, for example roller bearings or the like.

In an advantageous embodiment, the rotary knob unit and the stator unit are rotatably mounted on one another exclusively via the shaft and the hollow axle. In particular, the rotary knob unit is rotatably mounted exclusively with the shaft on the stator unit. In particular, the shaft is rotatably mounted exclusively on and/or within the hollow axle.

The rotatable mounting of the shaft in the hollow axle corresponds in particular to a radial bearing. It is possible for at least one axial bearing to be provided for axial forces. It is possible that the radial bearing is also designed to absorb axial forces.

In particular, the shaft is rotatably mounted relative to the hollow axle and preferably rotatably in the hollow axle by means of at least two bearing points. In particular, only two bearing points are provided. But it is also possible that at least three bearing points are provided. In particular, each bearing point has a bearing and, for example, a plain bearing or the like.

In a particularly advantageous embodiment, the bearing points are at a distance from one another which is greater than a maximum axial height of a rotary knob housing of the rotary knob unit. The distance is in particular an average distance between the bearing points. It is also possible that the distance is the clear distance between the bearing points. In particular, the ratio of the distance to the axial height is greater than 1 and preferably greater than 1.2 and particularly preferably greater than 1.5. It is also possible and advantageous for the ratio to be at least two or more.

It is preferred and advantageous that at least one of the bearing points is arranged outside the rotary knob housing. In particular, at least one of the bearing points is arranged within the rotary knob housing and/or radially within the first brake component (in particular the core). It is also possible and advantageous for at least two bearing points and in particular all bearing points to be arranged outside the rotary knob housing. In particular, the first brake component and preferably the core are housed in and/or on the rotary knob housing.

In particular, the gap and/or the coil is housed in and/or on the rotary knob housing. In particular, the casing part is arranged in and/or on the rotary knob housing. It is possible for all components of the rotary knob unit, with the exception of the shaft, to be arranged in and/or on the rotary knob housing or to provide part of the rotary knob housing. In other words, in an advantageous embodiment, the rotary knob unit is provided by the rotary knob housing and the shaft. The casing part preferably provides a (radial) outer wall of the rotary knob housing.

In particular, the shaft extends out of the rotary knob housing. In particular, the shaft only extends with one axial end out of the rotary knob housing. In particular, the shaft has an axial end connected to the rotary knob housing (preferably to an end plate of the rotary knob housing) and preferably connected in one piece.

The rotary knob housing is used in particular for touching with one or more fingers so that the rotary knob unit can be turned. In particular, the rotary knob housing defines the maximum radial expansion or the maximum diameter of the rotary knob unit. In particular, the rotary knob unit does not protrude radially outward beyond the rotary knob housing.

In particular, the rotary knob housing defines the axial height of the rotary knob unit if the shaft is not taken into account.

In a particularly preferred and advantageous embodiment, a maximum height of the rotary knob housing is smaller than a maximum diameter of the rotary knob housing. In particular, the maximum height is less than half of the maximum diameter. In particular, a maximum diameter of the rotary knob housing is equal to or smaller than 20 mm and preferably equal to or smaller than 15 mm and particularly preferably equal to or smaller than 10 mm.

The operating device can comprise at least one push button device. In particular, an input can be made via the push button device by pressing the rotary knob unit (press function or push function). This makes it possible for operating states to be carried out both by turning and by pressing the rotary knob unit. A rotary function is carried out in particular by turning the rotary knob unit. The rotary knob unit is held in particular by the rotary knob housing.

For the pressing function, it is in particular provided that the shaft can be axially displaceable relative to the first and second brake components by pressing the rotary knob unit from a basic position. In other words, when the knob unit is pressed, the shaft shifts relative to the first and second brake components. In particular, the shaft is axially displaceable relative to at least the casing part of the second brake component and/or the entire first brake component and/or the coil and/or the gap.

The shaft (for the pressing function) can preferably be inserted (axially) into the hollow axis. In particular, the shaft pushes its axial end out of the hollow axle.

In particular, the shaft is displaceable relative to at least a part of the rotary knob housing. In particular, it is provided that when the rotary knob housing is pressed, the shaft is pushed into the hollow axis, while part of the rotary knob housing remains fixed in place. In particular, the shaft is movable and preferably elastically connected to this part of the rotary knob housing. Such a connection can be made via a separate part and, for example, a joint. But the connection can also be done via the rotary knob housing itself. It is preferred and advantageous that the shaft is arranged on an at least partially flexible and preferably elastic section of the rotary knob housing.

In particular, the section is elastically deformable. In particular, the shaft and the section and the part of the rotary knob housing (which is fixed relative to the shaft) are firmly and preferably integrally connected to one another. Such a connection can be made, for example, in the manner of a film hinge or at least include one. The section of the rotary knob housing is in particular a front plate or part of the front plate. In particular, the front plate is at least partially elastic. In particular, the front plate enables a flexible and preferably elastic connection between the shaft and the part of the rotary knob housing which is fixed relative to the shaft during the pressing function. Such a deformable section of the rotary knob housing has the advantage that a seal can be dispensed with. An interruption of the housing for the pressing function would otherwise require an additional service point, which would take up installation space and increase the basic friction.

In particular, at least one reset device is provided. In particular, the shaft can be moved out of the hollow axle into the basic position by means of the reset device. The reset device is preferably provided by deforming an elastically formed section of the rotary knob housing when pressed. In particular, the section is the previously described section of the rotary knob housing. Preferably, the section returns to its original shape without any pressure actuation.

The reset device is particularly preferably formed integrally with the rotary knob housing and in particular with the front plate. The reset device can alternatively or additionally be provided by another (separate) part. For example, a spring element, for example, a snap disk (also called a snap dome), can be arranged between the stator unit and the rotary knob housing or at an end of the shaft distal to the rotary knob housing between the shaft and the support structure.

In particular, at least one sensor unit is provided for detecting a relative movement between the rotary knob unit and the stator unit. It is advantageous and preferred that the sensor unit is arranged outside the rotary knob housing and in particular also outside the hollow axle. In particular, the sensor unit is arranged in a stationary manner on the stator unit and/or on the strike structure. In particular, the sensor unit is arranged adjacent to a section of the shaft which extends out of the hollow axis. In particular, the sensor device overlaps with the shaft in the radial direction.

In particular, the sensor device overlaps with the hollow axis in the axial direction. This means that when the sensor unit is moved axially (in thought), it particularly hits the hollow axle.

In particular, the sensor unit is used to detect the rotational movement. It is also possible and preferred that the sensor unit is designed to detect the axial movement for the pressing function. Separate sensor units can also be provided for this.

In particular, the sensor unit has a distance from the coil which corresponds to at least 75% or at least 100% of the distance between the bearing points. In particular, the sensor unit has a distance from the coil that is greater than a maximum axial height of the rotary knob housing (for example 1, 2 times or 1.5 times or more). In particular, at least one sealing device for sealing the gap is arranged between the rotary knob unit and the stator unit. In particular, the sealing device extends between the rotary knob housing and the hollow axle. In particular, the sealing device (only) seals between the casing part and/or the base part and the hollow axle. In particular, the gap is only on one of the top or the side facing away from the face plate of the rotary knob housing (underside) is sealed. At the top, the rotary knob housing is particularly completely closed.

Preferably, the sealing device is arranged on and/or in the rotary knob housing and preferably only on and/or in the rotary knob housing. In particular, the sealing device is at least partially arranged radially inside of the coil. In particular, the sealing device is connected to the rotary knob unit only via the rotary knob housing and preferably via a base plate of the rotary knob housing.

The sealing device is preferably connected to the stator unit via the hollow axle and preferably only via the hollow axle.

The sealing device is preferably designed as a non-contact seal, in particular with at least one free sealing gap. The sealing device can be designed as a non-contact seal with at least one sealing fluid that closes the sealing gap.

In particular, the sealing fluid differs from the magnetorheological medium (e.g., size and/or type of particles). In particular, the sealing fluid is fixed by a magnetic field. Then the sealing fluid is preferably designed as a ferrofluid or the like. In particular, the sealing device then comprises at least one (permanent) magnet unit for generating a magnetic field. In particular, the sealing fluid reacts to the magnetic field without solidifying. In particular, the viscosity of the sealing fluid does not increase significantly under the influence of the magnetic field. The carrier fluid can be, for example, an aqueous solution, water, oil, wax or the like. Other carrier fluids suitable for sealing and for holding magnetizable sealing particles are also possible. The sealing fluid can include additives such as surfactants, stabilizers and the like. In particular, the sealing particles are stabilized with a surface coating, preferably a polymeric surface coating.

It is also possible and advantageous for the sealing fluid to be designed as a barrier grease. Then it is fixed in particular (also) due to its viscosity.

The sealing device can comprise or be designed as at least one labyrinth seal with at least two or more labyrinth walls. A free sealing gap and/or a sealing gap closed with the sealing fluid can be formed between the labyrinth walls.

The sealing device can also be designed as a contacting seal and can then in particular close at least one free sealing gap in a contacting manner. For this purpose, the sealing device can comprise at least one sealant made of an elastomer or felt or the like.

The magnetorheological medium preferably comprises magnetorheological particles and gas as a filling medium. In particular, the magnetorheological particles are absorbed in air. In particular, the magnetorheological medium is designed as a powder. With such a magnetorheological medium, the invention presented here enables a particularly low basic torque. Another advantage of particles taken up in gas is that there is no need for a compensation volume, which would otherwise be necessary with liquid media due to temperature fluctuations. However, a liquid medium is also possible, for example, with oil as a filling medium.

It is particularly preferred that the magnetorheological particles (each) consist predominantly of carbonyl iron powder or derivatives thereof. Other magnetorheologically responsive particles are also possible. The magnetorheological particles can have coatings to protect against abrasion and/or corrosion and/or additional components in order to make the magnetorheological particles more durable, more abrasion-resistant and/or more slippery during operation. The magnetorheological medium and/or the magnetorheological particles can, for example, include a graphite addition.

In a particularly advantageous embodiment, the core is connected to the hollow axle in a rotationally fixed manner. In particular, the first brake component is designed in one piece. It is possible and advantageous for the core to be connected in one piece to the hollow axle. It is also possible and advantageous for the core to be firmly joined to the hollow axle and, for example, pressed. An adhesive connection or the like is also possible. In particular, the hollow axle can be mounted directly or indirectly on the support structure.

In particular, the core is connected to the hollow axle via a support disk. The support disk extends in particular like a flange at one end of the hollow axle. The support disk can be formed in one piece with the hollow axle and/or with the core. In a particularly preferred embodiment, the support disk is connected in one piece to the hollow axle. The core is preferably joined to the support disk and, for example, pressed. However, the core can also be formed in one piece with the support disk. The support disk can be provided by the core or provided by the hollow axle or can be designed as a separate part from the core and hollow axle. It is particularly preferred and advantageous that the stator unit is designed as a single component that can be handled during the marriage with the rotary knob unit. In particular, this component includes the hollow axle and the first brake component attached to it (via the support disk) or consists of these parts. It is preferred and advantageous that the stator unit consists only of the hollow axle and the first brake component (which is preferably only provided by the core) attached to it (via the support disk).

The core is preferably annular. The core preferably has at least one circumferential receiving zone for the coil on the radial outside. The core preferably has at least one circumferential gap contour radially on the outside. The gap contour preferably comprises at least one star contour or is designed as such. The star contour in particular has a plurality of magnetic field concentrators protruding in the direction of the gap. In particular, this results in a circumferential gap with a variable gap height. The gap contour can also be flat or be cylindrical, so that there is no variable gap height.

In particular, at least two gap contours are provided. The receiving zone is preferably arranged between at least two gap contours. In particular, the coil is set back between the two gap contours. In particular, the gap contours extend beyond the coil in the direction of the casing part.

In particular, the hollow axis is arranged radially inside of the core. In particular, the support disk extends between the core and the hollow axle. The core can also be called a toroidal core.

In all configurations, it is preferred and advantageous that the rotary knob unit is connected to the casing part in a rotationally fixed manner Wave includes. In particular, at least one electrical line for the coil runs between the shaft and the hollow axle. In particular, the line runs through the wall of the hollow axle and/or through the support disk into the receiving zone to the coil.

It is advantageous and preferred that the shaft protrudes from the stator unit and in particular from the hollow axle at an axial end facing away from the rotary knob unit.

It is also preferred and advantageous that the shaft protrudes from the stator unit and in particular from the hollow axle at an axial end facing the rotary knob unit. In particular, the shaft protrudes from the stator unit and in particular from the hollow axle at two opposite axial ends. In particular, the hollow axle is designed to be shorter than the shaft.

In an advantageous development it is provided that the hollow axle and the shaft are each longer than an axial height of the rotary knob housing. It is particularly preferred that a section of the shaft which protrudes from the hollow axle has a length which is at least three quarters of the axial height of the rotary knob housing.

It is also advantageous and preferred that a section of the hollow axle, which protrudes from the rotary knob housing, has a length which is greater than an axial height of the rotary knob housing.

In particular, the shaft is connected to the casing part via an end plate. In particular, the end plate is solid and preferably formed in one piece with the shaft and/or with the casing part.

It is preferred that an end plate closes off the rotary knob unit to the outside (axially) and provides part of the rotary knob housing. In particular, the rotary knob unit consists only of the rotary knob housing and the shaft. In particular, the rotary knob housing consists only of the second brake component and preferably only the casing part and a face plate and a base part.

In particular, the rotary knob housing is axially supported on the first brake component via at least one sliding ring. In particular, the rotary knob housing is supported on the core. In particular, the rotary knob housing is supported by the face plate. In particular, support is also provided between the base part and the first braking component. In particular, at least one sliding ring is provided for each support.

The rotary knob housing has, in particular, a cylindrical outer contour. In particular, the shaft extends centrally out of the rotary knob housing. In particular, the shaft extends out of the rotary knob housing on a side facing away from the end plate. In particular, with the exception of the shaft, all components of the rotary knob unit are arranged within the rotary knob housing or form part of the rotary knob housing.

In particular, the rotary knob unit comprises at least one base part connected to the casing part in a rotationally fixed manner. In particular, the base part is arranged on a side facing away from the end plate. In particular, the base part has a central opening through which the hollow axis extends out of the rotary knob housing. In particular, the axis of rotation also runs through the central opening.

The casing part is preferably designed to be magnetically conductive. In particular, the casing part is made of a magnetically conductive material. In the context of the present invention, a magnetically non-conductive material is understood to mean in particular a material with a permeability number of less than ten and preferably less than one. Magnetically conductive here is understood to mean in particular materials with a permeability number of greater than ten and preferably ferromagnetic materials. The magnetic conductivity is the “relative magnetic permeability”, which is also simply called “magnetic permeability”.

In a particularly advantageous embodiment, the casing part has a maximum axial height which is at least 75% and preferably at least 85% and particularly preferably at least 90% of the maximum axial height of the rotary knob housing. In particular, the casing part is designed as a ring. In particular, the casing part connects the front plate with the base part. In particular, the casing part provides a wall of the rotary knob housing.

Further advantages and features of the present invention emerge from the description of the exemplary embodiments, which are explained below with reference to the accompanying figures.

Show in the figures:

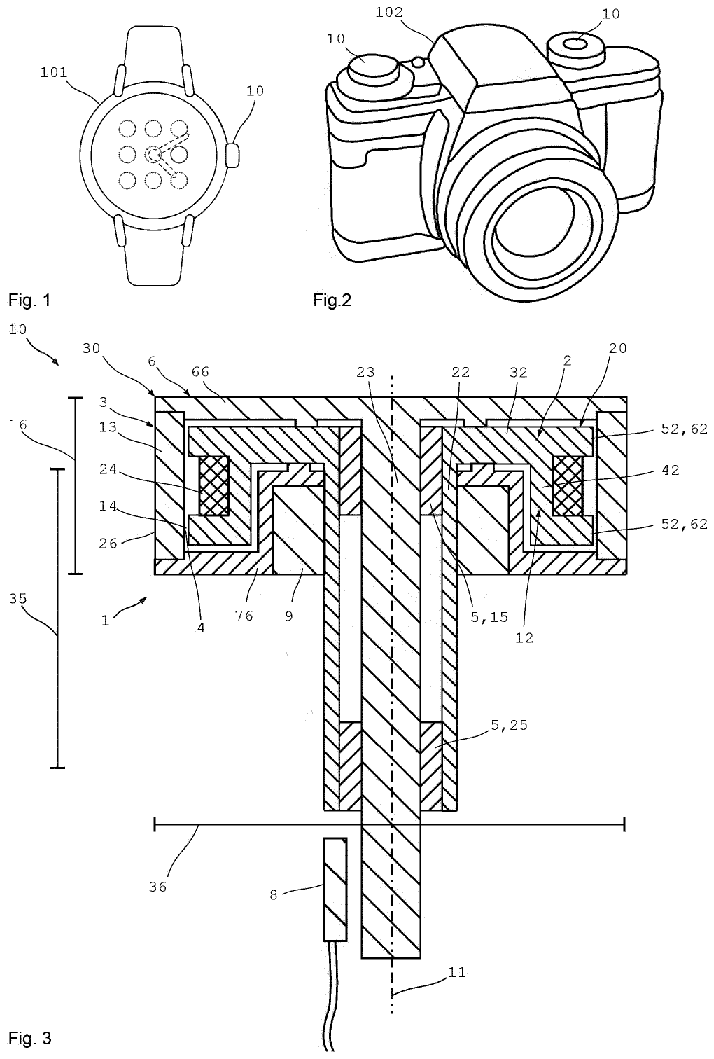

FIG. 1 shows a purely schematic representation of an operating device according to the invention; 23

FIG. 2 shows a purely schematic representation of a further operating device according to the invention;

FIG. 3 shows a purely schematic representation of an operating device according to the invention in a sectioned side view;

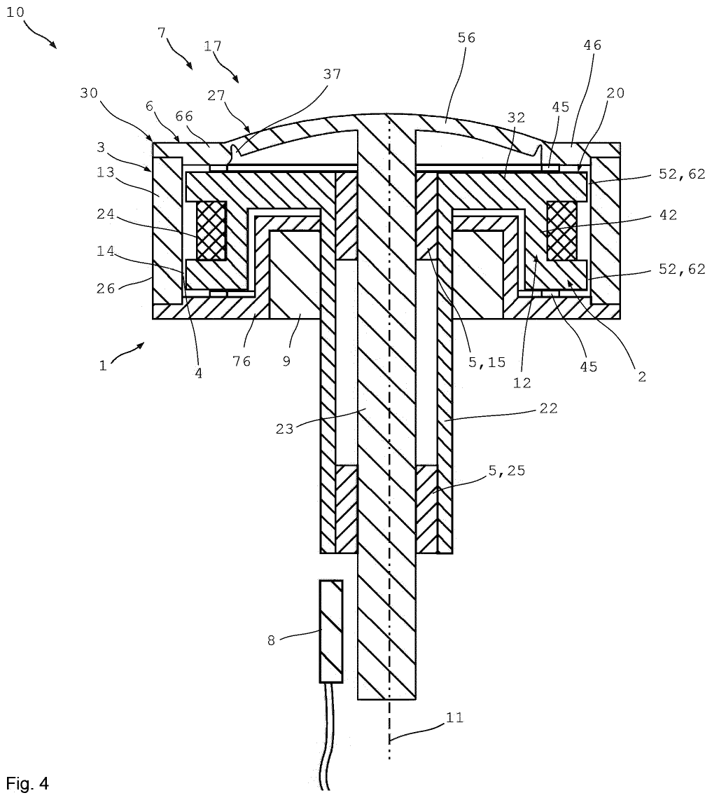

FIG. 4 shows a purely schematic representation of a further operating device according to the invention in a sectioned side view;

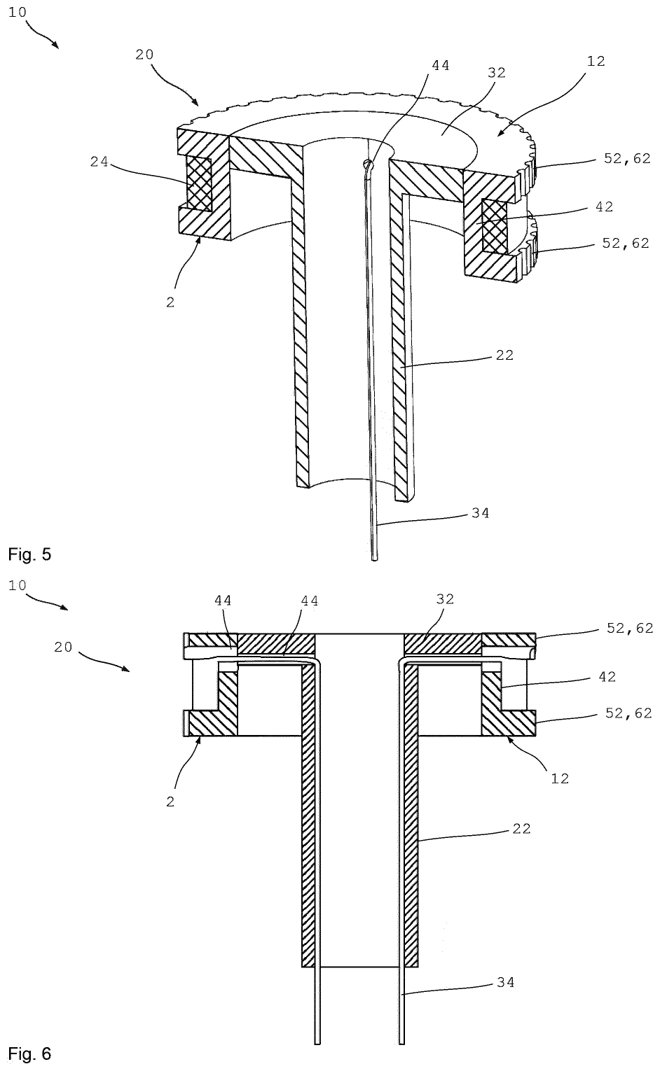

FIG. 5 shows a detailed representation of an operating device according to the invention in a sectioned perspective view; and

FIG. 6 shows the operating device of FIG. 5 in a sectioned side view.

FIG. 1 shows a smart device designed as a smartwatch 101, which is equipped with a haptic operating device 10. The Smartwatch 101 has a dynamic display. The operating device 10 can be used to operate functions of the smartwatch 101 using rotary movements and preferably also linear movements (push function). The operating device 10 can be used, for example, to scroll through menu items, apps, etc. or to set the time or volume or the like.

FIG. 2 shows a camera 102 with one or two haptic operating devices 10. Various functions of the camera 102 can be operated using the operating devices 10, for example aperture, shutter speed, ISO, focus, etc. One or both operating devices 10 can also be equipped with a push button function, so that a dialog can be confirmed or options can be specified by pressing a button. For example, the shutter release can also be activated by pressing the operating device 10.

FIG. 3 shows an operating device 10 with a stator unit 20 and a rotary knob unit 30, which can be rotated relative to one another. The relative movement can be braked in a targeted manner and provided with haptic feedback via a braking device 1 with two braking components 2, 3 and a gap 4 and a coil 24 and a magnetorheological medium 14. The rotational movement takes place around the axis of rotation 11.

The rotary knob unit 30 includes a casing part 13 and a shaft as well as an end plate 66 and a base part 76. The end plate 66 and the base part 76 are connected to one another via the casing part 13. The base part 76 and the end plate 66 as well as the casing part 13 form a rotary knob housing 6 here. The casing part 13 provides an outer wall 26 of the rotary knob housing 6. The shaft 23 extends out of the rotary knob housing 6. A maximum diameter 36 of the rotary knob unit 30 or the rotary knob housing 6 is, for example, less than 10 mm.

The stator unit 20 here comprises the first braking component 2 and a hollow axle 22 attached to it. The first braking component 2 here comprises a core 12 with a receiving zone 42 for the coil 24 and two gap contours 52. The gap contours 52 are designed here as star contours 62. The core 12 is connected to the hollow axle 22 via a support disk 32.

A sensor unit 8 is used to detect rotary movements and preferably also linear movements of the rotary knob unit 30 relative to the stator unit 20. The sensor unit in particular comprises at least one Hall sensor or the like.

The rotary knob unit 30 is here rotatably mounted on the stator unit 20 via two spaced bearing points 15, 25. The bearing points 15, 25 are arranged between the shaft 23 and the hollow axle 22 and are each provided here by a plain bearing 5. The average distance 35 between the bearing points 15, 25 or the plain bearings 5 is greater here than a maximum axial height 16 of the rotary knob housing 6.

A sealing device 9 serves to seal the gap 4. The sealing device 9 extends here between the rotary knob housing 6 and, for example, its base part 76 and the stator unit 20 and, for example, its hollow axis 22. The sealing device 9 can be designed here in a contacting or non-contact manner. With a non-contact seal, for example, a barrier grease or a magnetically fixed sealing fluid and, for example, a ferrofluid are provided.

FIG. 4 shows a variant of the operating device 10 presented in FIG. 3, with a push-button device 7 being provided here. This allows input to be made by pressing the rotary knob unit 30 (push function). By pressing, the shaft 23 is pushed into the hollow axle 22 along the axis of rotation 11 or pushed out of it at the lower end. The linear movement is also detected via the sensor unit 8.

The operating device 10 is shown here in a basic position 17, in which there is no pressure on the rotary knob unit 30. When pressed, the shaft 22 is displaced relative to a part 46 of the rotary knob housing 6. The shaft 23 is movable and, for example, elastically connected to this part 46. The connection here takes place via an elastically deformable section 56 of the rotary knob housing 6. For example, the section 56 is provided by the end plate 66. For this purpose, the end plate 66 is designed to be elastic and has, for example, a circumferential notch in order to increase the freedom of movement when pressing.

With a reset device 27, the rotary knob unit 30 can be returned to the basic position 17. The reset device 27 is provided here by the elastically designed section 56. The push button device 7 presented here has the advantage that it does not require any interruption or sealing in the otherwise closed rotary button housing 6.

A stator unit 20 is shown in more detail in FIGS. 5 and 6, as can be used, for example, in the operating devices 10 described above. Here are shown the star contour in 62 and the receiving zone 42 formed between them particularly easy to see for the coil 24. The hollow axle 22 is here formed in one piece with the support disk 32. The hollow shaft 22 is pressed into the annular core 12 via the support disk 32. 16 However, a one-piece design of core 12 and support disk 32 or hollow axle 2 and 20 may be provided.

One or more lines 34 for powering the coil 24 run within the hollow axle 22. When installed as intended, the lines 34 run between the inner wall of the hollow axle 22 and the shaft 23. At one axial end, bores are formed in the hollow axle 22, through which the lines 34 extend to the receiving zone 42. For this purpose, holes for the lines 34 are also arranged in the core 12 and in the support disk 32. The holes here run in a radial direction. In the arrangement shown here, it is possible, for example, that drilling only needs to be done once in order to guide a line 34 from the interior of the hollow axle 22 into the receiving zone 42.

[symbol]

List of reference symbols:

1 braking device
2 brake component
3 brake component
4 gap
5 plain bearings
6 knob housing
7 push button
8 sensor unit
9 sealing device
10 operating device
11 axis of rotation
12 core
13 casing part
14 medium
15 bearing point
16 axial height
17 basic position
20 stator unit
22 hollow axle
23 shaft
24 coil
25 bearing point
26 outer wall
27 reset device
30 knob unit
32 support disk
34 line
35 distance
36 diameter
37 notch
42 receiving zone
44 bore
45 slide ring
46 part of the rotary knob
52 gap contour
56 section
62 star contour
66 end plate
76 base part
101 smartwatch
102 camera

1-37. (canceled)

38. A haptic operating device, comprising:
at least one stator unit configured to attach to a support structure;
at least one rotary button unit configured to rotate relative to the stator unit and for setting operating states by means of rotary movements;
at least one magnetorheological braking device having at least two brake components, a first brake component of the at least two brake components being the stator unit, and a second brake component of said at least two brake components being the rotary knob unit;
the at least two brake components being rotatable relative to one another about an axis of rotation, the first brake component having a core made of a magnetically conductive material, and the second brake component having a casing part extending around the first brake component;
a circumferential gap formed between the first brake component and second brake component and being at least partially filled with a magnetorheological medium; and
at least one electrical coil between the casing part and the core wound around the axis of rotation and at least partially surrounding the core.

39. The haptic operating device according to claim 38, wherein:
the stator unit has a hollow axle which is non-rotatably connected to the first brake component;
the rotary knob unit has a shaft connected to the second brake component; and
the shaft runs through the hollow axle.

40. The haptic operating device according to claim 39, wherein the rotary knob unit and the stator unit are rotatably mounted to one another exclusively via the shaft and the hollow axle.

41. The haptic operating device according to claim 39, wherein the shaft is rotatably mounted in the hollow axle by at least two bearing points.

42. The haptic operating device according to claim 41, wherein the bearing points have a distance from one another which is greater than a maximum axial height of a rotary knob housing of the rotary knob unit.

43. The haptic operating device according to claim 41, wherein at least one of the bearing points is arranged outside the rotary knob housing.

44. The haptic operating device according to claim 38, wherein the first brake component, the gap, and the coil are housed in and/or on a rotary knob housing of the rotary knob unit, and the casing part is arranged in and/or on the rotary knob housing.

45. The haptic operating device according to claim 38, wherein the casing part provides an outer wall of a rotary knob housing of the rotary knob unit.

46. The haptic operating device according to claim 38, wherein a maximum axial height of a rotary knob housing of the rotary knob unit is smaller than a maximum diameter of the rotary knob housing.

47. The haptic operating device according to claim 38, a maximum diameter of a rotary knob housing of the rotary knob unit is equal to or smaller than 20 mm.

48. The haptic operating device according to claim 39, further comprising a push-button device via which an input can be made by pressing the rotary knob unit, and wherein by pressing the rotary knob unit the shaft can be axially displaced from a basic position relative to the first and second brake components.

49. The haptic operating device according to claim 39, wherein the shaft can be inserted into the hollow axle.

50. The haptic operating device according to claim 39, wherein the shaft is displaceable relative to at least one part of a rotary knob housing of the rotary knob unit, and the shaft is movably connected to the part of the rotary knob housing.

51. The haptic operating device according to claim 39, wherein the shaft is arranged on an at least partially flexible and preferably elastic section of a rotary knob housing of the rotary knob unit.

52. The haptic operating device according to claim 39, wherein the shaft is configured to move out of the hollow axle into the basic position by a reset device.

53. The haptic operating device according to claim 38, further comprising at least one sensor unit for detecting a relative movement between the rotary knob unit and the stator unit, and the sensor unit being arranged outside a rotary knob housing.

54. The haptic operating device according to claim 38, further comprising at least one sealing device for sealing the gap being arranged between the rotary knob unit and the stator unit.

55. The haptic operating device according to claim 54, wherein the sealing device is arranged on and/or in a rotary knob housing and the sealing device is at least partially arranged radially inside of the coil.

56. The haptic operating device according to claim 54, wherein the sealing device is a non-contact seal with at least one free sealing gap or as a non-contact seal with a sealing fluid closing the sealing gap, and the sealing fluid is fixed by a magnetic field or the sealing fluid is designed as a barrier grease.

57. The haptic operating device according to claim 38, wherein the magnetorheological medium has magnetorheological particles and gas as a filling medium.

58. The haptic operating device according to claim 39, wherein the core is connected to the hollow axle in a rotationally fixed manner.

59. The haptic operating device according to claim 38, wherein the core is annular and has at least one circumferential receiving zone for the coil radially on the outside and has at least one circumferential gap contour on the radial outside.

60. The haptic operating device according to claim 59, wherein the receiving zone is arranged between at least two gap contours.

61. The haptic operating device according to claim 38, wherein the rotary knob unit comprises a shaft connected in a rotationally fixed manner to the casing part.

62. The haptic operating device according to claim 61, wherein the shaft protrudes from a hollow axle of the stator unit at an axial end facing away from the rotary knob unit.

63. The haptic operating device according to claim 61, wherein the shaft protrudes from a hollow axle of the stator unit at an axial end facing the rotary knob unit.

64. The haptic operating device according to 39, wherein the hollow axle and the shaft are each longer than an axial height of a rotary knob housing.

65. The haptic operating device according to claim 62, wherein a section of the shaft which protrudes from the hollow axle has a length which is at least three quarters of the axial height of the rotary knob housing.

66. The haptic operating device according to claim 62, wherein a section of the hollow axle, which protrudes from a rotary knob housing, has a length which is greater than an axial height of the rotary knob housing.

67. The haptic operating device according to claim 62, wherein the shaft is connected to the casing part via an end plate and the end plate is formed integrally with the shaft and/or the casing part.

68. The haptic operating device according to claim 67, wherein an end plate closes the rotary knob unit to the outside and provides part of a rotary knob housing.

69. The haptic operating device according to 68, wherein the rotary knob housing is axially supported on the first brake component via at least one sliding ring.

70. The haptic operating device according to claim 42, wherein the rotary knob housing has a cylindrical outer contour and the shaft extends centrally out of the rotary knob housing.

71. The haptic operating device according to claim 38, wherein the rotary knob unit has a base part connected in a rotationally fixed manner to the casing part.

72. The haptic operating device according to claim 71, wherein a sealing device seals between the casing part and/or the base part and the hollow axle.

73. The haptic operating device according to claim 38, wherein the casing part is designed to be magnetically conductive.

74. The haptic operating device according to claim 38, wherein the casing part has an axial height which is at least 75% and preferably at least 85% and particularly preferably at least 90% of the axial height of a rotary knob housing of the rotary knob unit.
